(19) United States
(12) Patent Application Publication
(10) Pub. No.: US 2025/0159092 A1
(43) Pub. Date: May 15, 2025

(54) INFORMATION PROCESSING APPARATUS, METHOD FOR CONTROLLING THE SAME, AND STORAGE MEDIUM

(71) Applicant: CANON KABUSHIKI KAISHA, Tokyo (JP)

(72) Inventor: YUICHI KONDO, Chiba (JP)

(21) Appl. No.: 18/942,161

(22) Filed: Nov. 8, 2024

(30) Foreign Application Priority Data
Nov. 13, 2023 (JP) 2023-192965

(51) Int. Cl. H04N 1/32; H04N 1/00

(52) U.S. Cl. CPC H04N 1/32128; H04N 1/00212; H04N 1/0022; H04N 2201/0094

(57) ABSTRACT

An information processing apparatus includes a reception unit configured to receive image data and transmission source information about the image data from an external apparatus, a generation unit configured to generate a file from the received image data, and a setting unit configured to acquire identification information corresponding to the received transmission source information from a database, and set a name including the identification information for the generated file.

### BACKGROUND

### Field of the Invention

The present invention relates to an information processing apparatus, a method for controlling the same, and a storage medium.

### Description of the Related Art

At pharmacies outside of hospitals, prescription image data is sometimes sent from hospitals or patients using facsimile (FAX). In dispensing medications, the image data transmitted and received is therefore to be associated with patient information.

Japanese Patent Application Laid-Open No. 2018-18417 discusses a technique for storing an image file received by FAX, where the sender's FAX number is set as the filename.

In the case of pharmacies, identification information such as patient numbers is often assigned to individual patients for management purposes, and medical documents like prescriptions are also managed using the identification information. For example, setting the identification information for filenames can facilitate management.

### SUMMARY

The present disclosure is directed to facilitating the association of received image data with an individual's identification information.

According to an aspect of the present disclosure, an information processing apparatus includes a reception unit configured to receive image data and transmission source information about the image data from an external apparatus, a generation unit configured to generate a file from the received image data, and a setting unit configured to acquire identification information corresponding to the received transmission source information from a database, and set a name including the identification information for the generated file.

Further features of the present disclosure will become apparent from the following description of exemplary embodiments with reference to the attached drawings.

### BRIEF DESCRIPTION OF THE DRAWINGS

FIG. 1 is a diagram illustrating an example of a network configuration according to a first exemplary embodiment.

FIG. 2 is a diagram illustrating an example of a configuration of image forming apparatuses according to the first exemplary embodiment.

FIG. 3 is a diagram illustrating an example of a document for an image forming apparatus according to the first exemplary embodiment to read.

FIG. 4 is a diagram illustrating an example of a home screen displayed on a display unit immediately after the activation of the image forming apparatus according to the first exemplary embodiment.

FIG. 5 is a diagram illustrating an example of a connection relationship between the image forming apparatus and an electronic medical record system according to the first exemplary embodiment.

FIG. 6 is a diagram illustrating an example of a facsimile (FAX) transmission button registration screen displayed on the display unit during FAX transmission button registration processing according to the first exemplary embodiment.

FIG. 7 is a flowchart illustrating an example of the FAX transmission button registration processing according to the first exemplary embodiment.

FIG. 8 is a diagram illustrating an example of operation screens during FAX transmission according to the first exemplary embodiment.

FIG. 9 is a flowchart illustrating an example of FAX transmission processing according to the first exemplary embodiment.

FIG. 10 is a flowchart illustrating an example of patient information input processing according to the first exemplary embodiment.

FIG. 11 is a diagram illustrating an example of a home screen displayed on a display unit immediately after the activation of another image forming apparatus according to the first exemplary embodiment.

FIG. 12 is a diagram illustrating an example of a connection relationship between another image forming apparatus, a pharmacy system, and a file storage according to the first exemplary embodiment.

FIG. 13 is a diagram illustrating an example of a connection relationship between the pharmacy system and the file storage according to the first exemplary embodiment.

FIG. 14 is a diagram illustrating an example of a FAX reception registration screen according to the first exemplary embodiment.

FIG. 15 is a flowchart illustrating an example of FAX reception registration processing according to the first exemplary embodiment.

FIG. 16 is a flowchart illustrating an example of FAX reception processing according to the first exemplary embodiment.

FIG. 17 is a flowchart illustrating an example of FAX reception image data transfer processing according to the first exemplary embodiment.

FIG. 18 is a sequence diagram illustrating an example of a signal response sequence during FAX transmission and reception according to the first exemplary embodiment.

### DESCRIPTION OF THE EMBODIMENTS

Exemplary embodiments of the present disclosure will be described in detail below with reference to the drawings. The following exemplary embodiments are not intended to limit the invention set forth in the claims, and all combinations of features described in the exemplary embodiments are not necessarily essential to the solving means of the disclosure.

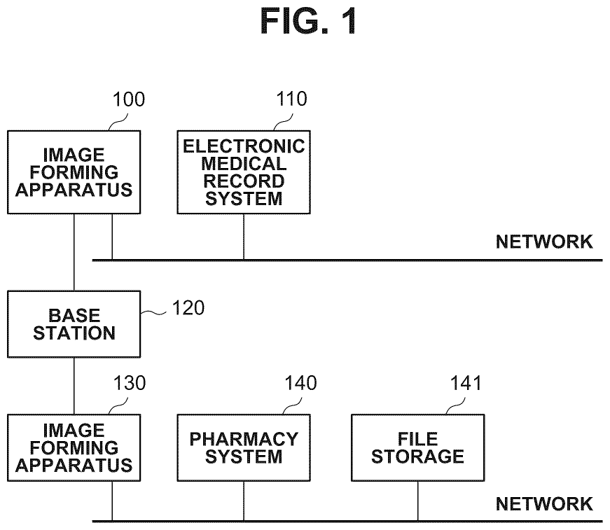

FIG. 1 is a diagram illustrating an example of a network configuration according to a first exemplary embodiment. In the present exemplary embodiment, a base station 120 connects an image forming apparatus 100 and an image forming apparatus 130 via a public switched telephone network (PSTN) (PSTN line) in a mutually communicable state. The method for connecting the image forming apparatuses 100 and 130 is not limited to the PSTN (PSTN line), and the Internet may be used. Such networks may use wired or wireless connections. In the case of the Internet connection, the base station 120 may be a network device such as a server. The image forming apparatus 100 is connected to an electronic medical record system 110 via a network in a mutually communicable state. The image forming apparatus 130 is connected to both a pharmacy system 140 and a file storage 141 via a network in a mutually communicable state. The networks connected to the respective image forming apparatuses 100 and 130 may be the Internet or local area networks (LANs). Such networks may use wired or wireless connections.

The image forming apparatuses 100 and 130 are examples of information processing apparatuses. The image forming apparatus 100 accepts input of image data to be transmitted, and converts the image data into a signal. The image forming apparatus 100 also acquires patient information and document type information related to the image data from the electronic medical record system 110, and associates the input image data with the acquired information. The image forming apparatus 100 transmits the signal of the associated image data and a signal containing the acquired information to the base station 120 via the PSTN (PSTN line). The image data may be directly input to the image forming apparatus 100 using a scan function, or input through data reception from another information processing apparatus.

The electronic medical record system 110 is a system that stores and manages the numbers, names, dates of birth, and diagnoses of patients in a hospital, for example. A patient information database (DB) 500 is stored in the electronic medical record system 110. The patient information DB 500 stores patient information such as patient numbers, patient names, patient statuses, addresses, and contact numbers, for example.

The base station 120 can determine the receiving image forming apparatus 130 from the signals transmitted from the image forming apparatus 100, mediate signal exchanges with the image forming apparatus 100, and control transmission of the image data to the image forming apparatus 130.

The image forming apparatus 130 is connected to the pharmacy system 140, and acquires patient information and document type information related to the image data from a patient information DB 1200 based on the received signals. The image forming apparatus 130 generates an image file based on the received image data, sets the acquired information for the filename of the generated image file, and transmits the image file to the file storage 141. The image forming apparatus 130 may receive the image data via an external network such as the PSTN (PSTN line), or directly using a scan function.

The pharmacy system 140 includes a not-illustrated display unit, and stores a database where identification information to be used for identifying patients is associated with transmission source information. The pharmacy system 140 provides the information stored in the database when accessed from outside. The display unit (not illustrated) of the pharmacy system 140 may be configured on the same apparatus as the storage location of the database, or on another apparatus such as a personal computer that can refer to the storage location of the database. The database stored in the pharmacy system 140 may be a predetermined one to not be updated with new information, or one that can be updated. The database may be transmitted from outside and stored into the pharmacy system 140. The database may be updated or stored, or both updated and stored, through learning by the pharmacy system 140.

The file storage 141 is a location where various types of data such as image data are stored. For example, the file storage 141 is a file server including a hard disk drive (HDD) or a solid-state drive (SSD). The file storage 141 has functions of recording data input from outside and outputting stored data to outside through communication, and can modify the stored contents.

The image forming apparatus 100 and the electronic medical record system 110 may be located on the same device. The image forming apparatus 130, the pharmacy system 140, and the file storage 141 may be respective independent apparatuses, or some or all of them may be located on the same device.

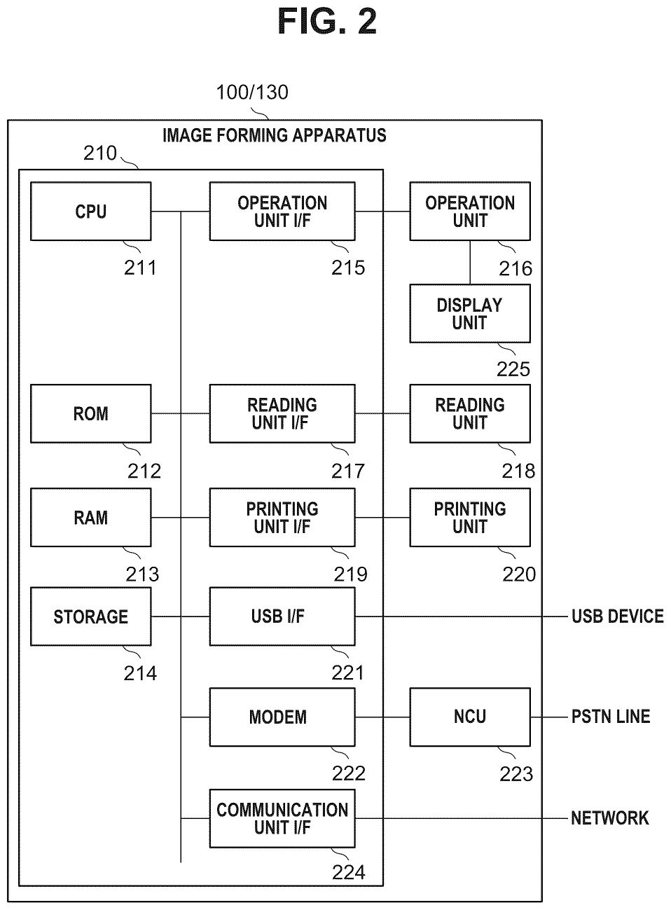

FIG. 2 is a diagram illustrating an example of a configuration of the image forming apparatuses 100 and 130 according to the present exemplary embodiment. Each image forming apparatus mainly includes a control unit 210, an operation unit 216, a reading unit 218, a printing unit 220, and a network control unit (NCU) 223. The control unit 210 includes a central processing unit (CPU) 211, a read-only memory (ROM) 212, a random access memory (RAM) 213, a storage 214, a modem 222, and various interfaces (I/Fs). The various I/Fs include an operation unit I/F 215, a reading unit I/F 217, a printing unit I/F 219, a Universal Serial Bus (USB) I/F 221, and a communication unit I/F 224.

The operation unit I/F 215 is a connecting unit between the control unit 210 and the operation unit 216, and connects the control unit 210 and the operation unit 216. The reading unit I/F 217 is a connecting unit between the control unit 210 and the reading unit 218, and connects the control unit 210 and the reading unit 218. The printing unit I/F 219 is a connecting unit between the control unit 210 and the printing unit 220, and connects the control unit 210 and the printing unit 220. The USB I/F 221 is a connecting unit between the control unit 210 and a USB device, and connects the control unit 210 and the USB device. The communication unit I/F 224 is a connecting unit between the control unit 210 and the network, and connects the control unit 210 and the network. The modem 222 is a connecting unit between the control unit 210 and the NCU 223, and connects the control unit 210 and the NCU 223. The NCU 223 is a connecting unit between the image forming apparatus and the PSTN line, and connects the image forming apparatus and the PSTN line.

The control unit 210 including the CPU 211 controls operation of the entire image forming apparatus. The CPU 211 reads a control program stored in the ROM 212 or the storage 214, and performs various types of control including a read control and a print control. The CPU 211 also receives signals accepted by various units of the image forming apparatus, and makes determinations in various processes. The ROM 212 stores control programs executable by the CPU 211. The ROM 212 also stores a boot program and font data, for example. The RAM 213 is a main memory of the CPU 211 and used as a work area. The RAM 213 is used as a temporary storage area for loading various control programs stored in the ROM 212 and the storage 214. The storage 214 stores various types of information, including image data, print data, an address book, various programs, and various types of setting information, for example. In the present exemplary embodiment, the storage 214 is assumed to be a flash memory. However, auxiliary storage devices such as an SSD, an HDD, and an embedded MultiMediaCard (eMMC) may be used. In the present exemplary embodiment, the image forming apparatus 100 is configured so that a single CPU 211 performs various processes using a single memory (RAM 213) as illustrated in flowcharts to be described below. However, other configurations are also acceptable. For example, a plurality of CPUs, RAMs, ROMs, and storages may perform the processes in a cooperative manner. Some of the processes may be performed using a hardware circuit such as an application-specific integrated circuit (ASIC) and a field-programmable gate array (FPGA).

The operation unit 216 includes an input device such as a button. The input device may be one capable of display operation as well as input operation, like a touchscreen. The operation unit 216 displays information to the user and detects input from the user. The operation unit 216 may include a plurality of input devices, or a display device such as a screen in addition to the input device. The image forming apparatus may include this display device as a display unit 225 aside from the operation unit 216. In the present exemplary embodiment, the operation unit 216 will be described to include the display unit 225 that is capable of input operation as well as display operation.

The reading unit 218 reads a document and generates image data, such as binary data, based on the read document image. The image data generated by the reading unit 218 is transmitted to an external apparatus such as an information processing apparatus, stored in an external recording device such as a USB device, or printed on a sheet, for example.

The printing unit 220 receives image data to be printed from the CPU 211, and prints an image on a recording sheet fed from a feed cassette (not illustrated). The operation of the printing unit 220 is not limited to printing on a sheet of paper. For example, the printing unit 220 may print on a non-paper medium such as an overhead projector (OHP) sheet.

The modem 222 modulates and demodulates signals to be used for facsimile (FAX) communication. The NCU 223 performs processing for transmitting and receiving dial signals. Specifically, the NCU 223 transmits a signal modulated by the modem 222 to the PSTN (PSTN line). The CPU 211 can acquire patient information, such as information about a patient identification (ID) card, from a USB device, such as a card reader, via the USB I/F 221. The control unit 210 is connected to the network via the communication unit I/F 224, and transmits image data to an external apparatus and receives image data from an external apparatus.

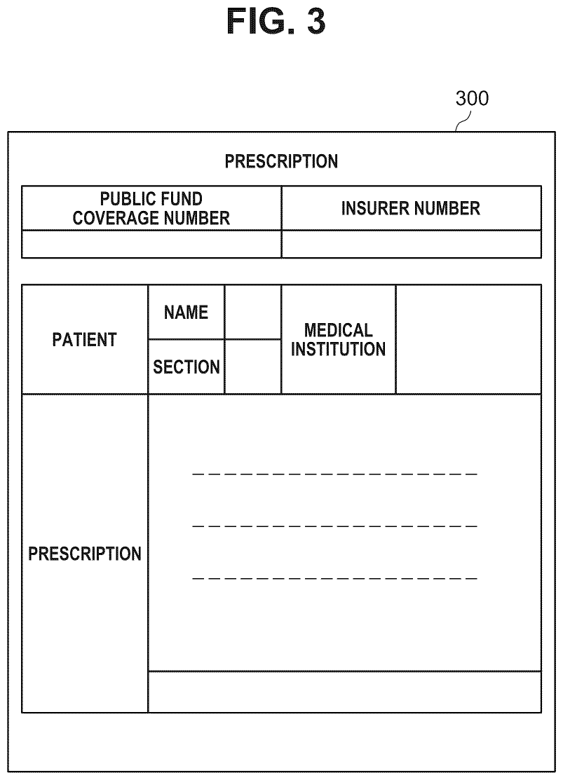

FIG. 3 is a diagram illustrating an example of a document for the image forming apparatuses 100 and 130 according to the present exemplary embodiment to read. A document 300 is a prescription, which is a document describing the types, dosages, and use instructions of medicines for treating a patient's illness, written by a doctor. In the case of a dispensing pharmacy, a pharmacist checks whether the specifications of the prescription is appropriate, prepares the medicines accordingly, and provides the medicines to the patient.

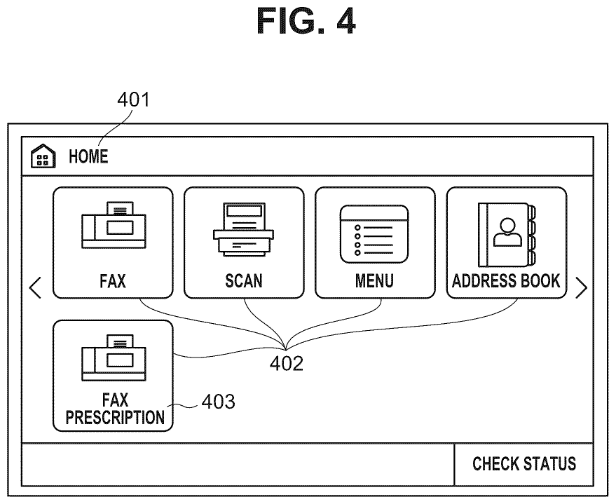

FIG. 4 is a diagram illustrating an example of a home screen displayed on the display unit 225 immediately after the activation of the image forming apparatus 100 according to the present exemplary embodiment. A home screen 401 is a screen for issuing instructions to perform various functions of the image forming apparatus 100, and displayed on the display unit 225. The home screen 401 displays function buttons 402 for various functions for the image forming apparatus 100 to perform, such as a FAX button.

The function buttons 402 are buttons for issuing instructions to performing the functions of the image forming apparatus 100, and if one of the function buttons 402 is selected, the corresponding function is performed. The display unit 225 displays one of a plurality of function button pages where the plurality of function buttons 402 is laid out. The screens to be displayed may be displayed as a single page, for example, by scrolling the screens, resizing the function buttons 402, or adjusting the layout. The user can register new function buttons 402.

A prescription FAX transmission button 403 is an example of a function button 402, a button for performing a function of reading a prescription and transmitting the image data via FAX. Note that the function buttons 402 described in the present exemplary embodiment are not mechanical input devices such as physically featured buttons, but icons displayed on the display unit 225. However, mechanical buttons may be provided. The functions of function buttons 402 that can be added are not limited to FAX transmission, and may be functions such as email transmission and file transmission.

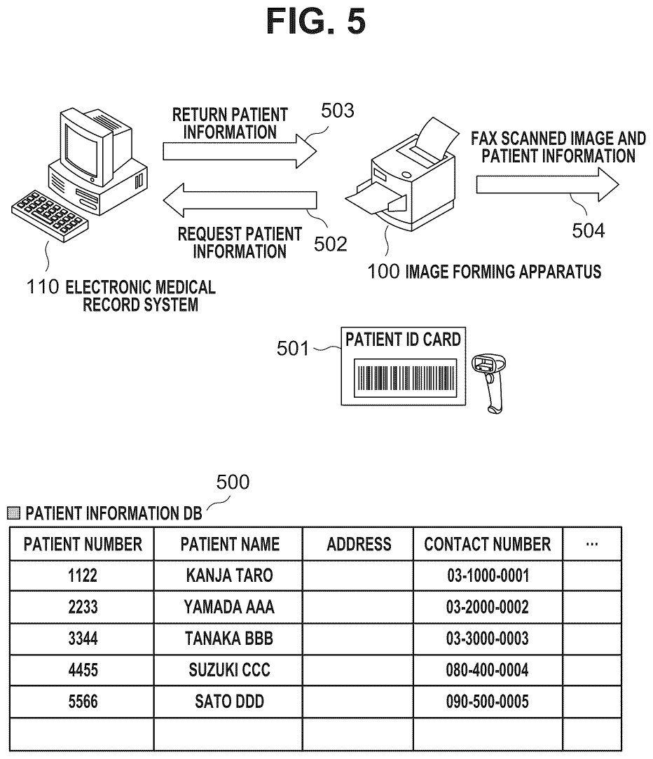

FIG. 5 is a diagram illustrating an example of a connection relationship between the image forming apparatus 100 and the electronic medical record system 110 according to the present exemplary embodiment. The electronic medical record system 110 stores the patient information DB 500. The information DB 500 is updated at timing such as patient registration, reception, hospital admission registration, and billing. For example, patient numbers, patient names, patient statuses, addresses, and contact numbers are stored in the patient information DB 500 as patient information. The image forming apparatus 100 acquires the patient information DB 500 through communication with the electronic medical record system 110. Alternatively, the patient information DB 500 may be stored in the storage 214 inside the image forming apparatus 100 in advance, and data may be acquired within the image forming apparatus 100.

If the prescription FAX transmission button 403 is selected by the user, the image forming apparatus 100 displays a not-illustrated input screen on the display unit 225. If the patient number on a patient ID card 501 is input by the user, the image forming apparatus 100 transmits the patient number to the electronic medical record system 110 and requests acquisition of registered patient information (502). The patient number may be input using a keyboard, or by reading a code that indicates numerals and letters, such as a one-dimensional code like a barcode and a two-dimensional code like a Quick Response (QR) code (registered trademark). The image forming apparatus 100 may include a device capable of reading and writing information, and acquire the information by a contact method using a magnetic card, a punched card, or a memory card. The image forming apparatus 100 may include a reader-writer, for example, and acquire the information by a noncontact method using radio frequency identification (RFID) or near field communication (NFC). The image forming apparatus 100 may include a microphone and acquire the information using a voice-based input method. The electronic medical record system 110, upon receiving the request for patient information from the image forming apparatus 100, refers to the patient information DB 500, and returns the patient information (such as a patient name and contact number) corresponding to the requested patient number to the image forming apparatus 100 (503). The information that the electronic medical record system 110 returns to the image forming apparatus 100 may be a part of the patient information. All the patient information may be returned by the electronic medical record system 110, and stored in the storage 214 of the image forming apparatus 100 for use. The image forming apparatus 100 then transmits the signal containing the scanned image of the read prescription and the acquired patient information, via FAX (504).

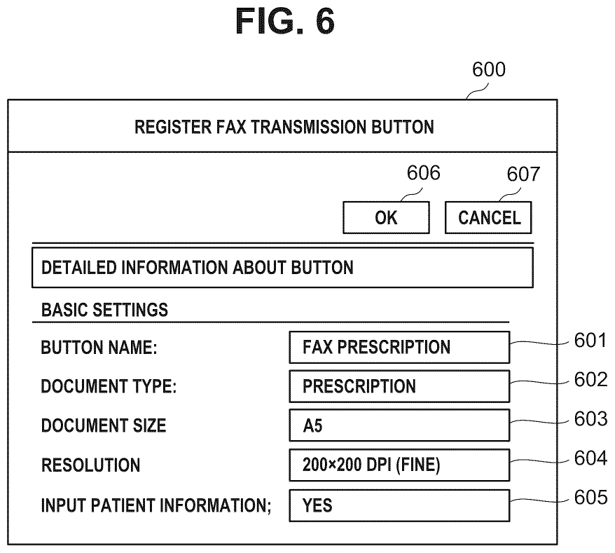

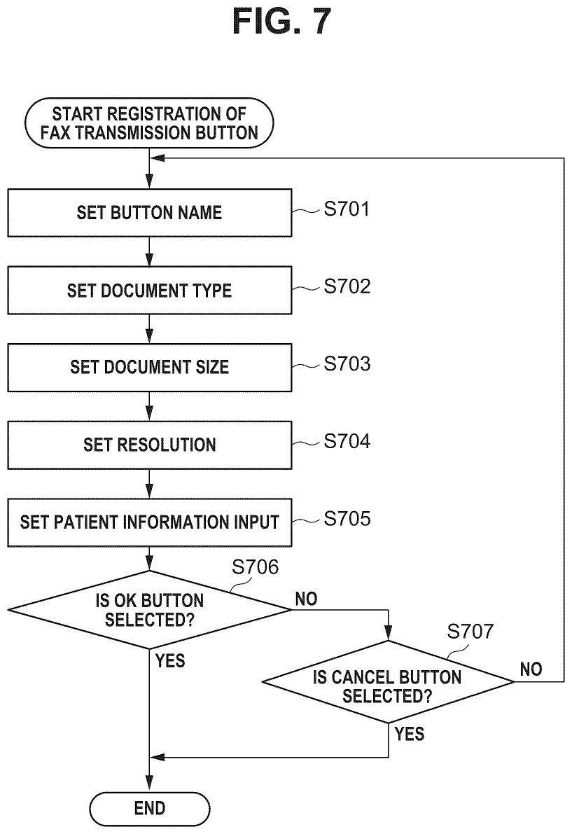

FIG. 7 is a flowchart illustrating an example of registration processing of a FAX transmission button that is a type of function button 402. FIG. 6 is a diagram illustrating an example of a FAX transmission button registration screen 600 displayed on the display unit 225 during the FAX transmission button registration processing. The FAX transmission button registration processing is started when the user operates the operation unit 216 and selects the registration of a FAX transmission button from button registration items on a setting screen. When the registration of a FAX transmission button is selected by the user, the image forming apparatus 100 displays the FAX transmission button registration screen 600 on the display unit 225. Alternatively, the FAX transmission button may be registered via a webpage provided by the image forming apparatus 100, for example. The FAX transmission button may be registered by accessing the image forming apparatus 100 using an external apparatus such as a personal computer. Processing to be performed by the CPU 211 of the image forming apparatus 100 will now be described.

### [Step S701: Setting Button Name]

In step S701, the CPU 211 accepts the setting of a button name by the user. If an input field 601 on the FAX transmission button registration screen 600 is selected, the CPU 211 displays a not-illustrated software keyboard on the display unit 225, and the user can input a desired button name using the software keyboard. Once the input to the input field 601 is completed, the processing proceeds to step S702.

### [Step S702: Setting Document Type]

In step S702, the CPU 211 accepts the setting of a document type by the user. If an input field 602 on the FAX transmission button registration screen 600 is selected, the CPU 211 displays a not-illustrated software keyboard on the display unit 225, and the user can input the document type using the software keyboard. The document type may be input not only by the input from the software keyboard, but also through selection from options corresponding to registered document types. The user may input more than one document type. For example, if “prescription” and “interview form” are input as document types, the image of the first document among a plurality of documents scanned by the user using the reading unit 218 may be FAXed as a prescription, and the image of the second document as an interview form. Once the input to the input field 602 is completed, the processing proceeds to step S703.

### [Step S703: Setting Document Size]

In step S703, the CPU 211 accepts the setting of a document size by the user. If an input field 603 on the FAX transmission button registration screen 600 is selected, the CPU 211 displays options corresponding to registered document sizes on the display unit 225, and the user can input a document size by selecting one of the options. The image forming apparatus 100 may acquire the size of the document placed on the reading unit 218, and set the acquired size as the document size.

Once the input to the input field 603 is completed, the processing proceeds to step S704.

### [Step S704: Setting Resolution]

In step S704, the CPU 211 accepts the setting of a resolution by the user. If an input field 604 on the FAX transmission button registration screen 600 is selected, the CPU 211 displays options corresponding to registered reading resolutions on the display unit 225, and the user can input a resolution by selecting one of the options. The options for the document type, document size, and resolution may be registered by the time when the user selects the options, i.e., may be registered by the user in advance or stored in the storage 214 or the ROM 212 in advance. Once the input to the input field 604 is completed, the processing proceeds to step S705.

### [Step S705: Setting Patient Information Input]

In step S705, the CPU 211 accepts the setting of patient information input by the user.

If an input field 605 on the FAX transmission button registration screen 600 is selected, the CPU 211 displays alternatives on the display unit 225, and the user can select either one of the alternatives. Examples of the alternatives may include 0 and 1, Yes and No, and various symbols such as ✓ and x. If the user sets the patient information input to “yes” as in FIG. 6, the patient information such as a patient name and contact number can be input at the time of FAX transmission. Once the input to the input field 605 is completed, the processing proceeds to step S706.

[Step S706: Determining Selection of OK button]

In step S706, the CPU 211 determines whether an OK button 606 on the FAX transmission button registration screen 600 is selected. The OK button 606 is an object for registering the data that is input at the time of selection in association with the FAX transmission button. If the OK button 606 is determined to be selected (YES in step S706), the CPU 211 stores the data that is input at the time of the selection of the OK button 606 in association with the FAX transmission button to be registered, and the processing ends. If the OK button 606 is determined to not be selected (NO in step S706), the processing proceeds to step S707. In the example of FIG. 6, if the OK button 606 is selected, the CPU 211 stores the details of each setting item into the storage 214 as button information, like “FAX PRESCRIPTION” as the button name of the FAX transmission button to be registered, and “prescription” as the document type information.

### [Step S707: Determining Selection of Cancel Button]

In step S707, the CPU 211 determines whether a cancel button 607 on the FAX transmission button registration screen 600 is selected. The cancel button 607 is an object for discarding the data that is input at the time of selection and closing the FAX transmission button registration screen 600. If the cancel button 607 is determined to be selected (YES in step S707), the CPU 211 discards the data that is input at the time of upon the selection of the cancel button 607 and closes the FAX transmission button registration screen 600, and the processing ends. If the cancel button 607 is determined to not be selected (NO in step S707), the processing returns to step S701.

The FAX transmission button registered by the processing of the foregoing steps S701 to S707 is displayed on the home screen 401 of FIG. 4 (prescription FAX transmission button 403).

In the processing of steps S701 to S705, all the items do not necessarily need to be set. The order is not limited, either. The processing of steps S701 to S705 may be implemented by reading a file where the items are registered in advance into the image forming apparatus 100 from outside.

The determinations in steps S706 and S707 are not limited to the inputs from the display unit 225, and may be made with inputs from buttons provided on the operation unit 216 as the determination criteria, for example. Alternatively, the determinations of steps S706 and S707 may be omitted, and the processing may be automatically ended after a lapse of a predetermined time.

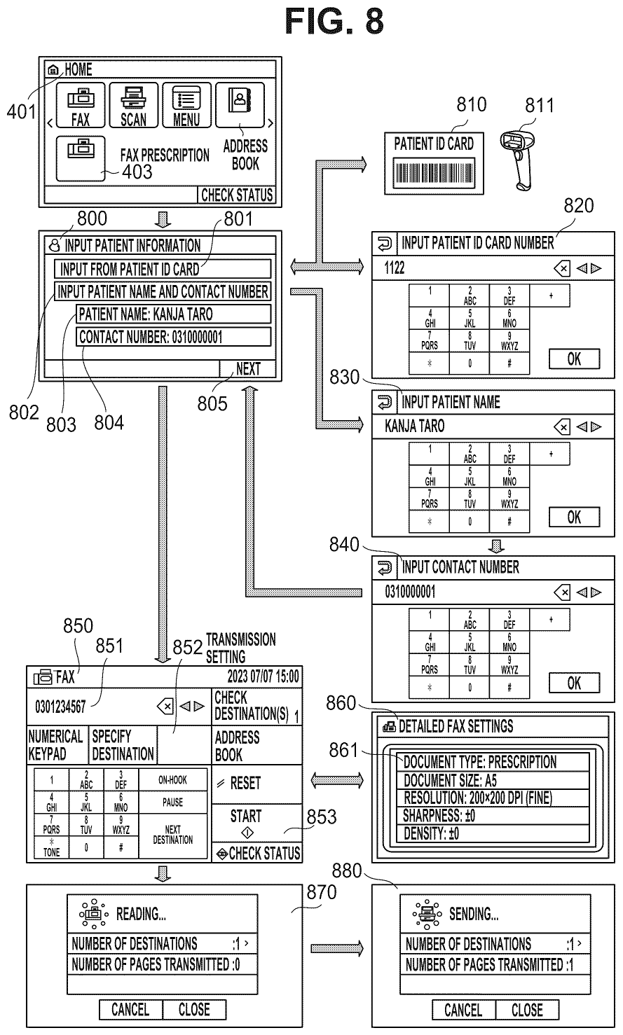

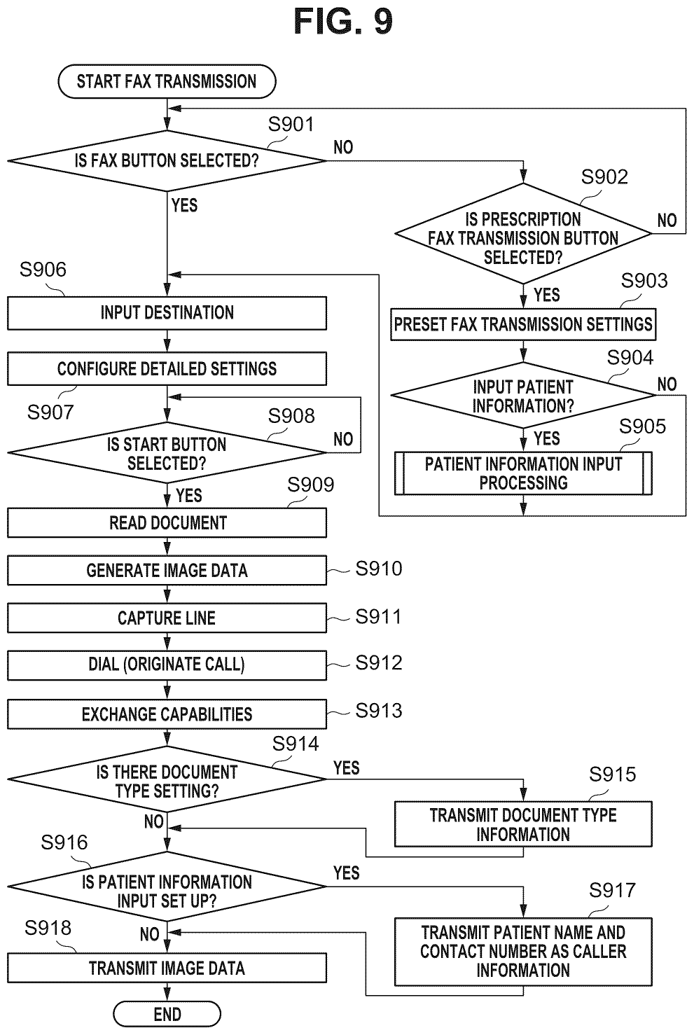

FIG. 9 is a flowchart illustrating an example of FAX transmission processing according to the present exemplary embodiment, which illustrates an example of a procedure where the image forming apparatus 100 reads the document 300 and transmits the image data to the image forming apparatus 130 by FAX. FIG. 8 is a diagram illustrating examples of operation screens during the FAX transmission. The FAX transmission processing is started when the user operates the operation unit 216 of the image forming apparatus 100 and selects the FAX button displayed on the home screen 401 or the function button 402 where the FAX transmission settings are registered. In the present exemplary embodiment, the prescription FAX transmission button 403 will be described as an example of the function button 402 where the FAX transmission settings are registered. Processing to be performed by the CPU 211 of the image forming apparatus 100 will now be described.

### [Step S901: Determining Selection of FAX Button]

In step S901, the CPU 211 determines whether the FAX button is selected. If the selected button is determined to be the FAX button (YES in step S901), the processing proceeds to step S906. If the selected button is determined to not be the FAX button (NO in step S901), the processing proceeds to step S902.

### [Step S902: Determining Selection of Prescription FAX Transmission Button]

In step S902, the CPU 211 determines whether the prescription FAX transmission button 403 is selected. If the selected button is determined to be the prescription FAX transmission button 403 (YES in step S902), the processing proceeds to step S903. If the selected button is determined to not be the prescription FAX transmission button 403 (NO in step S902), the processing proceeds to step S901. Note that the button to be determined here is not limited the “prescription FAX transmission button”. For example, the button may be function buttons 402 where other names or document types are set, such as a “report FAX transmission button”.

### [Step S903: Presetting FAX Transmission Settings]

In step S903, for FAX transmission settings, the CPU 211 presets the transmission settings (such as the document type “prescription” and the document size “A5”) set by the user in advance in registering the FAX transmission button (prescription FAX transmission button) (FIGS. 6 and 7). Once the presetting is completed, the processing proceeds to step S904.

### [Step S904: Determining Whether to Input Patient Information]

In step S904, the CPU 211 determines whether the setting of the patient information input (input field 605) set in advance in registering the FAX transmission button (prescription FAX transmission button) (FIGS. 6 and 7) is “yes”. If the setting of the patient information input is determined to be “yes” (YES in step S904), the processing proceeds to step S905. If the setting of the patient information input is determined to not be “yes” (NO in step S904), the processing proceeds to step S906.

### [Step S905: Inputting Patient Information]

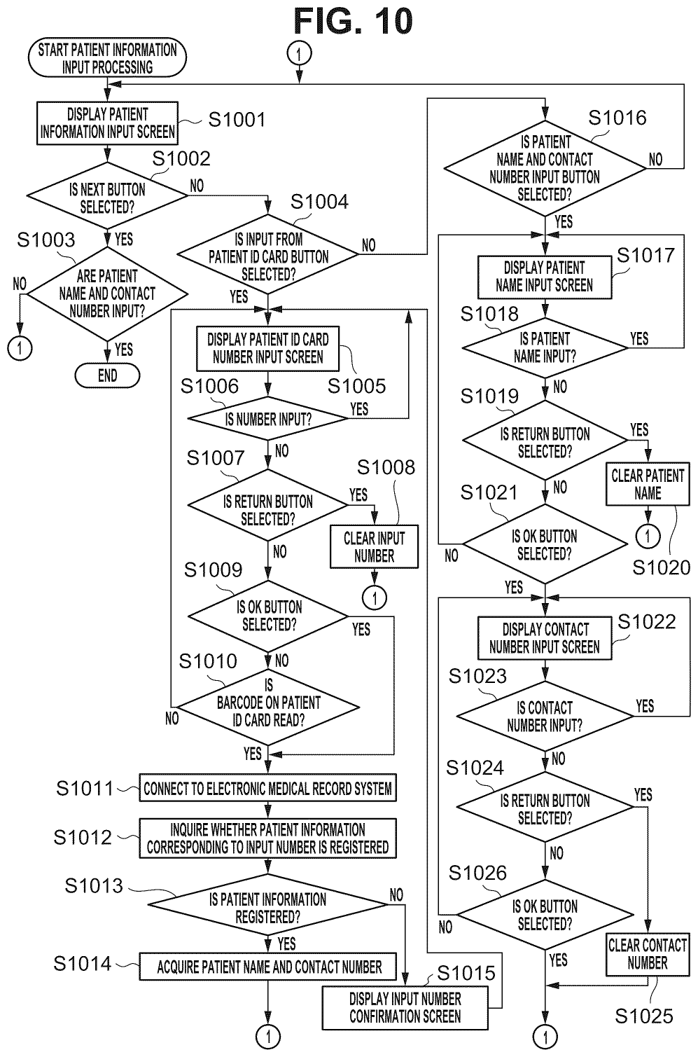

In step S905, the CPU 211 performs patient information input processing (FIG. 10) to be described below. Once the patient information input processing is completed, the processing proceeds to step S906.

### [Step S906: Inputting Destination]

In step S906, the CPU 211 accepts the input of a transmission destination by the user. If a next button 805 on a patient information input screen 800 is selected, the CPU 211 displays a FAX setting screen 850 on the display unit 225. The FAX setting screen 850 includes a transmission destination input field 851 and a transmission setting button 852. The user can input the transmission destination by selecting the destination input field 851. Once the input of the destination is completed, the processing proceeds to step S907.

### [Step S907: Configuring Detailed Settings]

In step S907, the CPU 211 configures detailed settings that include reading settings such as a document size and a reading mode and transmission settings such as a transmission resolution. If the transmission setting button 852 on the FAX setting screen 850 is selected, the CPU 211 displays a detailed FAX setting screen 860 on the display unit 225, and the user can configure the detailed settings. On the detailed FAX setting screen 860, the user can change the setting values of the document size, reading mode, and transmission resolution during FAX transmission. For example, the user can set document types to notify the recipient machine of during FAX transmission by selecting a document type setting button 861. Once the detailed settings are completed, the processing proceeds to step S908.

### [Step S908: Determining Selection of Start Button]

In step S908, the CPU 211 determines whether a start button 853 is selected. The start button 853 is not limited to the one on the display unit 225, and may be ones to be selected on other input devices, such as a button on the operation unit 216.

The button name is not limited to the word “start”, either. For example, the button may be named “next”. If the start button 853 is determined to be selected (YES in step S908), the processing proceeds to step S909. If the start button 853 is determined to not be selected (NO in step S908), the processing returns to step S908 to wait until the start button 853 is selected.

### [Step S909: Reading Document]

In step S909, the CPU 211 reads a document via the reading unit 218. When the start button 853 is selected in step S908, the CPU 211 displays a reading-in-progress screen 870 indicating that the document is being read on the display unit 225, and starts reading the document. Once the reading of the document is completed, the CPU 211 displays a FAX transmission-in-progress screen 880 indicating that FAX transmission is in progress on the display unit 225. Once the reading of the document is completed, the processing proceeds to step S910.

### [Step S910: Digitizing Document]

In step S910, the CPU 211 generates image data such as binary data based on the document image read by the reading unit 218. Once the generation of the image data is completed, the processing proceeds to step S911.

### [Step S911: Capturing Line]

In step S911, the CPU 211 captures a line to initiate a call to the image forming apparatus 130 that is the transmission destination via the base station 120. Once the capturing of the line is completed, the processing proceeds to step S912.

### [Step S912: Dialing (Call Origination)]

In step S912, the CPU 211 of the image forming apparatus 100 dials (originates a call) to the image forming apparatus 130 using the line captured in step S911. Once the dialing (call origination) is completed, the processing proceeds to step S913.

### [Step S913: Exchanging Capabilities]

In step S913, the CPU 211 exchanges capabilities with the image forming apparatus 130 to which the call is originated in step S912. In this capability exchange, the CPU 211 and the image forming apparatus 130 exchange information such as the size and type of recording sheets, a modem type, an encoding method, and a recording resolution, whereby transmittable and receivable capability information is exchanged. Once the capability exchange is completed, the processing proceeds to step S914.

### [Step S914: Determining Document Type Setting]

In step S914, the CPU 211 determines whether there is a document type setting (step S702). If there is determined to be a document type setting (YES in step S914), the processing proceeds to step S915. If there is determined to be no document type setting (NO in step S914), the processing proceeds to step S916.

### [Step S915: Transmitting Document Type Information]

In step S915, the CPU 211 of the image forming apparatus 100 transmits the document type information set in step S702 to the image forming apparatus 130 that is the transmission destination. Once the transmission of the document type information is completed, the processing proceeds to step S916.

### [Step S916: Determining Patient Information Input]

In step S916, the CPU 211 determines whether the patient information input is set up (step S705). If the patient information input is determined to be set up (YES in step S916), the processing proceeds to step S917. If the patient information input is determined to not be set up (NO in step S916), the processing proceeds to step S918.

### [Step S917: Transmitting Patient Name and Contact Number as Caller Information]

In step S917, the CPU 211 of the image forming apparatus 100 transmits a patient name (sender name) displayed in a patient name display field 803 and a contact number (sender number) displayed in a contact number display field 804 to the image forming apparatus 130 as caller information. The FAX sender name is not limited to the patient name, as long as the name is the user's own name input to the image forming apparatus 100, for example. The FAX sender number is not limited to the contact number, and may be the FAX number assigned to the image forming apparatus 100 that transmits the FAX, for example. The information to be displayed in the patient name display field 803 and the contact number display field 804 is acquired in step S1014 to be described below.

Once the transmission of the caller information is completed, the processing proceeds to step S918.

### [Step S918: Transmitting Image Data]

In step S918, the CPU 211 of the image forming apparatus 100 transmits the image data to the image forming apparatus 130 via the PSTN line, using the modem 222 and the NCU 223. Once the FAX transmission is completed, the CPU 211 of the image forming apparatus 100 displays the FAX setting screen 850 on the display unit 225.

The processing of steps S901 to S918 may be performed based on operation instructions from an external apparatus such as a personal computer. The screens may be displayed not only on the display unit 225 of the image forming apparatus 100 but also on the external apparatus such as a personal computer.

FIG. 10 is a flowchart illustrating an example of patient information input processing according to the present exemplary embodiment.

The patient information input processing is performed in step S905 of the FAX transmission processing. Processing to be performed by the CPU 211 of the image forming apparatus 100 will now be described.

### [Step S1001: Displaying Patient Information Input Screen]

In step S1001, the CPU 211 displays the patient information input screen 800 on the display unit 225. The patient information input screen 800 includes an input from patient ID card button 801, a patient name and contact number input button 802, the patient name display field 803, and the contact number display field 804. Once the display of the patient information input screen 800 is completed, the processing proceeds to step S1002.

### [Step S1002: Determining Selection of Next Button]

In step S1002, the CPU 211 determines whether the next button 805 is selected. If the next button 805 is determined to be selected (YES in step S1002), the processing proceeds to step S1003. If a button other than the next button 805 is determined to be selected (NO in step S1002), the processing proceeds to step S1004.

### [Step S1003: Determining Input of Patient Name and Contact Number]

In step S1003, the CPU 211 determines whether a patient name and a contact number are input. If a patient name and a contact number are determined to be input (YES in step S1003), the processing ends (proceeds to step S906). If a patient name or a contact number is determined to not be input (NO in step S1003), the processing proceeds to step S1001.

[Step S1004: Determining Input from Patient ID Card]

In step S1004, the CPU 211 determines whether the input from patient ID card button 801 is selected. If the input from patient ID card button 801 is determined to be selected (YES in step S1004), the processing proceeds to step S1005. If a button other than the input from patient ID card button 801 is determined to be selected (NO in step S1004), the processing proceeds to step S1016.

### [Step S1005: Displaying Patient ID Card Number Input Screen]

In step S1005, the CPU 211 displays a patient ID card number input screen 820 on the display unit 225. Once the display of the patient ID card number input screen 820 is completed, the processing proceeds to step S1006.

### [Step S1006: Determining Input of Number]

In step S1006, the CPU 211 determines whether a number is input. If a number is determined to be input to the patient ID card number input screen 820 (YES in step S1006), the processing returns to step S1005 to wait for the completion of the number input. If a number is determined to not be input to the patient ID card number input screen 820 (NO in step S1006), the processing proceeds to step S1007.

### [Step S1007: Determining Selection of Return Button]

In step S1007, the CPU 211 determines whether the return button is selected. If the return button on the patient ID card number input screen 820 is determined to be selected (YES in step S1007), the processing proceeds to step S1008. If the return button on the patient ID card number input screen 820 is determined to not be selected (NO in step S1007), the processing proceeds to step S1009.

### [Step S1008: Clearing Input Number]

In step S1008, the CPU 211 clears the input number input to the patient ID card number input screen 820. Once the clearing of the input number is completed, the processing proceeds to step S1001.

### [Step S1009: Determining Selection of OK Button]

In step S1009, the CPU 211 determines whether the OK button is selected.

If the OK button is determined to be selected (YES in step S1009), the processing proceeds to step S1011. If a button other than the OK button is determined to be selected (NO in step S1009), the processing proceeds to step S1010.

### [Step S1010: Determining Whether Barcode on Patient ID Card Is Read]

In step S1010, the CPU 211 determines whether the barcode on the patient ID card is read. If the user reads the barcode on the patient ID card and the CPU 211 of the image forming apparatus 100 acquires the patient ID card number corresponding to the read barcode, the CPU 211 determines that the barcode is read. If the barcode on the patient ID card is determined to be read (YES in step S1010), the processing proceeds to step S1011. If the barcode on the patient ID card is determined to not be read (NO in step S1010), the processing proceeds to step S1005. The reading of the patient ID card number via barcode can be performed by reading the barcode on the patient ID card 810 using a barcode reader 811 that is connected to the image forming apparatus 100 and capable of communicating information. Note that the item to be read is not limited to a barcode. For example, one-dimensional codes and two-dimensional codes, such as a QR code, that indicate numerals and letters may be read. Alternatively, the image forming apparatus 100 may include a device capable of information reading and writing, and acquire the information from a magnetic card, a punched card, or a memory card in a contact manner. The image forming apparatus 100 may include a reader-writer, for example, and acquire the information by a noncontact method using RFID or NFC.

### [Step S1011: Connecting to Electronic Medical Record System]

In step S1011, the CPU 211 connects to the electronic medical record system 110. Once the connection to the electronic medical record system 110 is completed, the processing proceeds to step S1012.

### [Step S1012: Inquiring Patient Information Corresponding to Input Number]

In step S1012, the CPU 211 transmits the input patient ID card number to the electronic medical record system 110, and inquires whether patient information corresponding to the transmitted patient ID card number is registered in the patient information DB 500. If the received patient ID card number is registered in the patient information DB 500, the electronic medical record system 110 notifies the CPU 211 that the patient information is registered. The electronic medical record system 110 may issue a notification to the image forming apparatus 100 not only when the patient information is registered but also when the patient ID card number received by the electronic medical record system 110 from the image forming apparatus 100 is not registered in the patient information DB 500. Once the inquiry of the patient information is completed, the processing proceeds to step S1013.

### [Step S1013: Determining Whether Patient Information Is Registered]

In step S1013, the CPU 211 determines whether the patient information is registered in the patient information DB 500 of the electronic medical record system 110. The CPU 211, if notified by the electronic medical record system 110 in step S1012, determines that the patient information is registered. If not notified, the CPU 211 determines that the patient information is not registered. The CPU 211 may determine that the patient information is not registered if a notification that the patient information is not registered is received from the electronic medical record system 110. If the patient information is determined to be registered (YES in step S1013), the processing proceeds to step S1014. If the patient information is determined to not be registered (NO in step S1013), the processing proceeds to step S1015.

### [Step S1014: Acquiring Patient Name and Contact Number]

In step S1014, the CPU 211 acquires the patient name and the contact number from the patient information stored in the patient information DB 500. Once the acquisition of the patient name and the contact number is completed, the processing proceeds to step S1001. In step S1001, the CPU 211 reflects and displays the acquired patient name and contact number in the patient name display field 803 and the contact number display field 804 of the patient information input screen 800, respectively.

### [Step S1015: Displaying Input Number Confirmation Screen]

In step S1015, the CPU 211 displays a not-illustrated input number confirmation screen. Once the display of the input number confirmation screen is completed, the processing proceeds to step S1005.

### [Step S1016: Determining Whether to Input Patient Name and Contact Number]

In step S1016, the CPU 211 determines whether the patient name and contact number input button 802 is selected. If the patient name and contact number input button 802 is determined to be selected (YES in step S1016), the processing proceeds to step S1017. If the patient name and contact number input button 802 is determined to not be selected (NO in step S1016), the processing proceeds to step S1001.

### [Step S1017: Displaying Patient Name Input Screen]

In step S1017, the CPU 211 displays a patient name input screen 830 on the display unit 225. Once the display of the patient name input screen 830 is completed, the processing proceeds to step S1018.

### [Step S1018: Determining Input of Patient Name]

In step S1018, the CPU 211 determines whether a patient name is input on the patient name input screen 830. If a patient name is determined to be input (YES in step S1018), the processing returns to step S1017 to wait until the input of the patient name is completed. If a patient name is determined to not be input (NO in step S1018), the processing proceeds to step S1019.

### [Step S1019: Determining Selection of Return Button]

In step S1019, the CPU 211 determines whether the return button is selected.

If the return button is determined to be selected (YES in step S1019), the processing proceeds to step S1020. If the return button is determined to not be selected (NO in step S1019), the processing proceeds to step S1021.

### [Step S1020: Clearing Patient Name]

In step S1020, the CPU 211 clears the patient name input to the patient name input screen 830. Once the clearing of the patient name is completed, the processing proceeds to step S1001.

### [Step S1021: Determining Selection of OK Button]

In step S1021, the CPU 211 determines whether the OK button is selected.

If the OK button is determined to be selected (YES in step S1021), the processing proceeds to step S1022. If the OK button is determined to not be selected (NO in step S1021), the processing proceeds to step S1017.

### [Step S1022: Displaying Contact Number Input Screen]

In step S1022, the CPU 211 displays a contact number input screen 840 on the display unit 225. Once the display of the contact number input screen 840 is completed, the processing proceeds to step S1023.

### [Step S1023: Determining Input of Contact Number]

In step S1023, the CPU 211 determines whether a contact number is input. If a contact number is determined to be input (YES in step S1023), the processing returns to step S1022 to wait until the input of the contact number is completed. If a contact number is determined to not be input (NO in step S1023), the processing proceeds to step S1024.

### [Step S1024: Determining Selection of Return Button]

In step S1024, the CPU 211 determines whether the return button is selected.

If the return button is determined to be selected (YES in step S1024), the processing proceeds to step S1025. If the return button is determined to not be selected (NO in step S1024), the processing proceeds to step S1026.

### [Step S1025: Clearing Contact Number]

In step S1025, the CPU 211 clears the contact number input to the contact number input screen 840. Once the clearing of the contact number is completed, the processing proceeds to step S1001.

### [Step S1026: Determining Selection of OK Button]

In step S1026, the CPU 211 determines whether the OK button is selected. If the OK button is determined to be selected (YES in step S1026), the processing proceeds to step S1001. In step S1001, the CPU 211 reflects and displays the input patient name and contact number in the patient name display field 803 and the contact number display field 804 of the patient information input screen 800, respectively. If the OK button is determined to not be selected (NO in step S1026), the processing proceeds to step S1022.

The determinations in this processing are not limited to the inputs from the display unit 225, and may be made with inputs from buttons provided on the operation unit 216 as the determination criteria, for example. The reading by the barcode reader 811 is not limited to during the display of the patient ID card number input screen 820, and may be performed while the patient information input screen 800 is displayed, for example. The patient information for the image forming apparatus 100 to acquire may be acquired, for example, by the user registering the insurer information or his/her individual number (My Number) in the patient information DB 1200 in advance, and inputting the number written on an ID card such as a health insurance card and a My Number card.

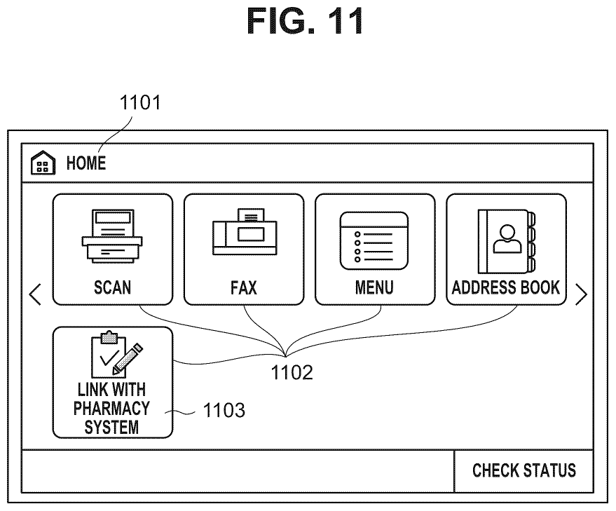

FIG. 11 is a diagram illustrating an example of a home screen displayed on the display unit 225 of the image forming apparatus 130 according to the present exemplary embodiment immediately after activation. A home screen 1101 is displayed on the display unit 225, and displays function buttons 1102 for issuing instructions to perform various functions of the image forming apparatus 130.

The function buttons 1102 are buttons for issuing instructions to performing the functions of the image forming apparatus 130, and if one of the function buttons 1102 is selected, the corresponding function is performed. The display unit 225 display one of a plurality of function button pages where the plurality of function buttons 1102 is laid out. The screens to be displayed may be displayed as a single page, for example, by scrolling the screens, resizing the function buttons 1102, or adjusting the layout. A pharmacy system link button 1103 is an example of a function button 1102, a button for performing the function of reading and storing prescriptions and interview forms brought by patients into the file storage 141. Note that the function buttons 1102 described in the present exemplary embodiment are not mechanical input devices such as physically featured buttons, but icons displayed on the display unit 225. However, mechanical buttons may be provided.

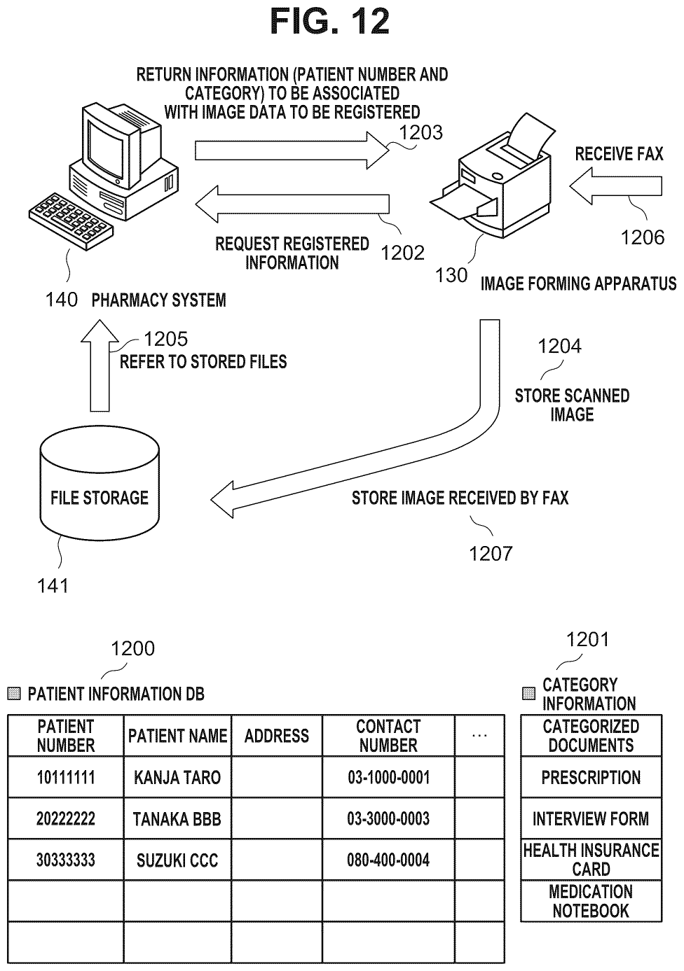

FIG. 12 is a diagram illustrating an example of a connection relationship between the image forming apparatus 130, the pharmacy system 140, and the file storage 141 according to the present exemplary embodiment. The pharmacy system 140 stores the patient information DB 1200. The information DB 1200 is updated at timing such as patient registration, reception, prescription registration, and billing. For example, patients' insurer numbers, patient names, addresses, and contact numbers are stored in the patient information DB 1200 as patient information. The image forming apparatus 130 acquires the data stored in the patient information DB 1200 through communication with the pharmacy system 140. Category information 1201 is category information about documents for the pharmacy system 140 to manage patient by patient. Examples of the category information about documents include prescriptions, interview forms, health insurance cards, and medication notebooks. The patient information DB 1200 may be stored in the storage 214 in the image forming apparatus 130 for direct acquisition. Alternatively, the patient information DB 1200 may be stored in the file storage 141, and the image forming apparatus 130 may acquire the patient information DB 1200 by communication. The category information 1201 may also be stored in the storage 214 in the image forming apparatus 130 for direct acquisition. The category information 1201 may be stored in the file storage 141, and the image forming apparatus 130 may acquire the category information 1201 by communication.

If the pharmacy system link button 1103 is selected by the user, the image forming apparatus 130 transmits the patient number to the pharmacy system 140 and requests acquisition of information to be associated with received image data (1202). Next, the pharmacy system 140 returns the patient number, patient name, and category information to be registered for the image file name to the image forming apparatus 130 (1203). The image forming apparatus 130 then sets the returned information for the filename of the generated image file and transmits the image file to the file storage 141, whereby the image file is stored (1204). The information that the pharmacy system 140 returns to the image forming apparatus 130 may be a part of the patient information stored in the patient information DB 1200. All the patient information may be returned and stored in the storage 214 of the image forming apparatus 100 for use. If category information about an image received via FAX (1206) is included in the document category information set in advance, the image forming apparatus 130 transmits the image received by FAX to the file storage 141 (1207). Here, if transmission source information such as the received FAX number and name is registered in the pharmacy system 140 as that of a patient, the image forming apparatus 130 acquires the patient number corresponding to the transmission source information from the patient information DB 1200. The image forming apparatus 130 further sets the acquired patient number for the filename of the generated image file and transmits the generated image file to the file storage 141 (1207), whereby the image file is stored. Instead of directly transmitting the image file to the file storage 141, the image forming apparatus 130 may be configured to transmit the image file to another information processing apparatus that executes the storage, for example.

The pharmacy system 140 can refer to the files stored in the file storage 141 (1205).

The acquisition of the information to be associated with the image data (1203) is not limited to when image data is transmitted, but may be performed at the activation of the image forming apparatus 130, upon recovery from a power saving state, or at regular timing.

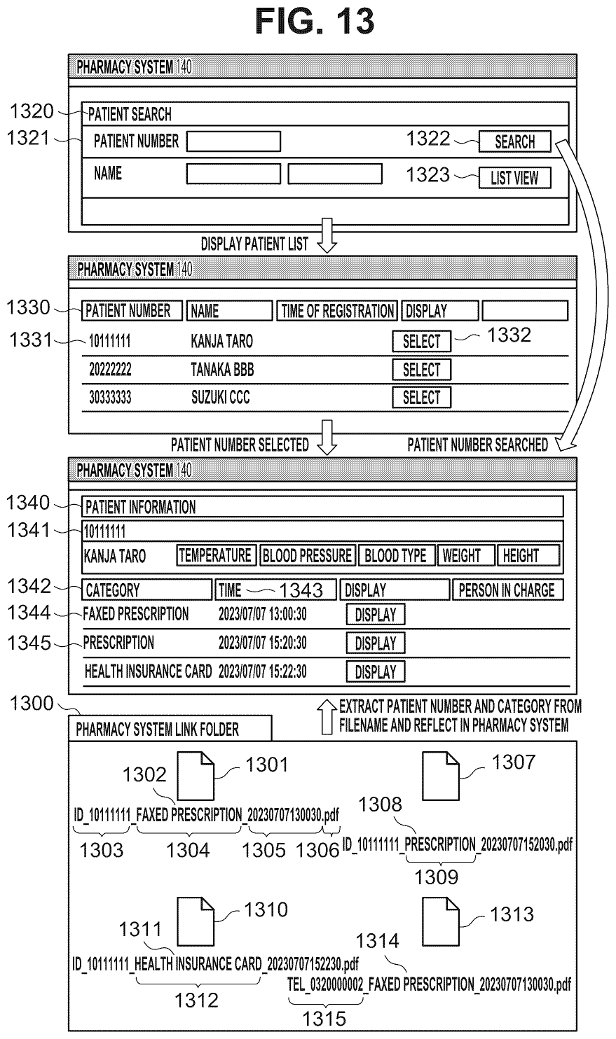

FIG. 13 is a diagram illustrating an example of a connection relationship between the pharmacy system 140 and the file storage 141 according to the present exemplary embodiment. A pharmacy system link folder 1300 is an example of the storage location of image files on the file storage 141. The image forming apparatus 130 can store image files by transmitting the image files to the file storage 141. FIG. 13 illustrates the pharmacy system link folder 1300 in a state after image files are stored by a pharmacy system link application. For example, if the image forming apparatus 130 acquires “10111111 Kanja Taro” from the patient information DB 1200 and acquires “prescription” and “health insurance card” from the categorized documents of the category information 1201, an image file 1307 and an image 1310 are generated. If the image forming apparatus 130 further receives image data about which the category information 1201 is set to “prescription” by FAX, an image file 1301 is generated. The image files 1301, 1307, and 1310, and an image file 1313 are generated by the image forming apparatus 130, and transmitted from the image forming apparatus 130 to the file storage 141, whereby the generated image files 1301, 1307, 1310, and 1313 are stored into the pharmacy system link folder 1300. The image file 1301 will now be described as an example. The image file 1301 is stored with the patient's patient number 1303, a document category 1304, a date and time of file generation 1305, and an extension 1306 set as a filename 1302. For example, the image forming apparatus 130 sets the filename 1302 like “ID_10111111_FAXED PRESCRIPTION_20230707130030.pdf”. The document category 1304 corresponds to the document type based on the category information 1201. For prescriptions, the document category 1304 is set to “PRESCRIPTION” (1309). For health insurance cards, the document category 1304 is set to “HEALTH INSURANCE CARD” (1312).

The image file 1313 is an example of an image file generated by the image forming apparatus 130 receiving a prescription by FAX. A filename 1314 is one where a contact number 1315 of the patient who visits the pharmacy for the first time is set, for example. The image forming apparatus 130 sets the filename 1314 like “TEL_0320000002_FAXED PRESCRPITION_20230707130030.pdf”. A filename can include an ID (patient number) like the filename 1302, or a contact number like the filename 1314. The setting method can be changed based on user settings. For example, the image forming apparatus 130 may determine whether the transmission source information is registered in the patient information DB 1200, and if the transmission source information is registered, automatically set the ID for the filename, and if not, automatically set the contact number for the filename. The elements of the filename to be set are not limited to only an ID or contact number, and may also include a document type and a date.

The pharmacy system 140 displays a patient search screen 1320 on a display unit (not illustrated) of an information processing apparatus such as a personal computer (PC) connected to the pharmacy system 140, and the user can check registered patients. The patient search screen 1320 includes a search button 1322 for searching for a patient based on a patient number input to a patient number input field 1321, and a list view button 1323 for listing patient numbers.

If the user selects the list view button 1323 on the patient search screen 1320, the display unit (not illustrated) of the information processing apparatus connected to the pharmacy system 140 transitions to a list view screen 1330. The list view screen 1330 displays, in a patient number field, patient numbers extracted from the filenames of the files stored in the pharmacy system link folder 1300.

If the user selects a selection button 1332 for selecting patient information to be browsed, the list view screen 1330 transitions to a patient information screen 1340 corresponding to the patient number. If the search button 1322 on the patient search screen 1320 is selected with a patient number input to the patient number input field 1321, the patient search screen 1320 also transitions to the patient information screen 1340. The patient information screen 1340 lists files with filenames that include the patient number matching a patient number 1341 among the files stored in the file storage 141. A document category 1342 displays the document category 1304 (1344) extracted from the filename 1302 of the image file 1301, for example. A time of registration 1343 displays the date and time of file generation 1305 (1345) included in the filename 1308 of the image file 1307, for example.

The image forming apparatus 130 transmits generated image files to the storage location of the storage destination. The storage location where the generated image files are stored is not limited to a folder like the pharmacy system link folder 1300. For example, the storage location may be a storage medium such as an HDD to which an Internet Protocol (IP) address is assigned, or a file server. For example, when the image file 1307 is generated, the image forming apparatus 130 may transmit the image file 1307 to a folder with a name including “ID_10111111” that is a part of the filename 1308. The image file name and the folder name do not necessarily need to match, and the image forming apparatus 130 may transmit an image file to a storage location based on the name of the image file according to a predetermined rule. The image forming apparatus 130 initially determines the first character. The image forming apparatus 130 then transmits the image file to a folder named after the first character of the column where the determined character belongs in Japanese syllabary. For example, if the name of the generated image file is “Tanaka”, the image file is stored in a folder named “Ta-column”. For example, if the name of the generated image file is “123”, the image forming apparatus 130 determines whether the last digit is even-numbered or odd-numbered, and transmits the image file to a folder “odd-numbered” between the folders “odd-numbered” and “even-numbered”. The image forming apparatus 130 may issue an instruction to generate a storage location, like a folder, as the storage destination of the generated image file, and transmit the image file to the storage location generated under the instruction. The image file generated by the image forming apparatus 130 may be transmitted to a storage location outside the image forming apparatus 130 as described in the present exemplary embodiment, or transmitted to a storage location inside the image forming apparatus 130.

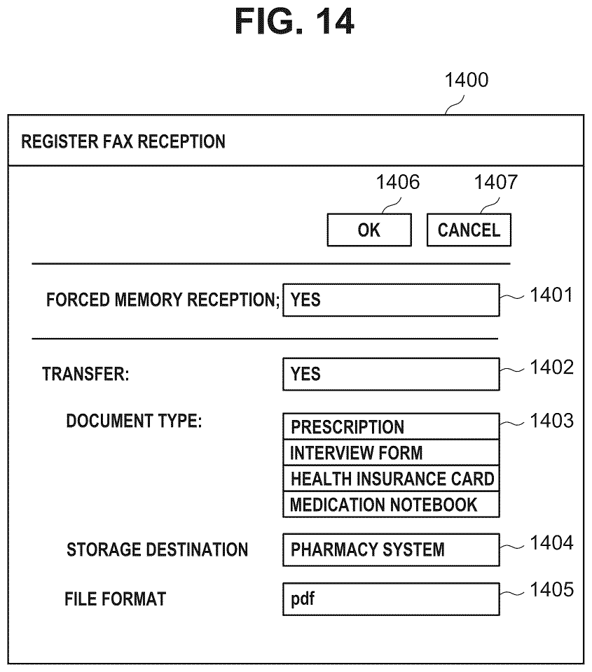

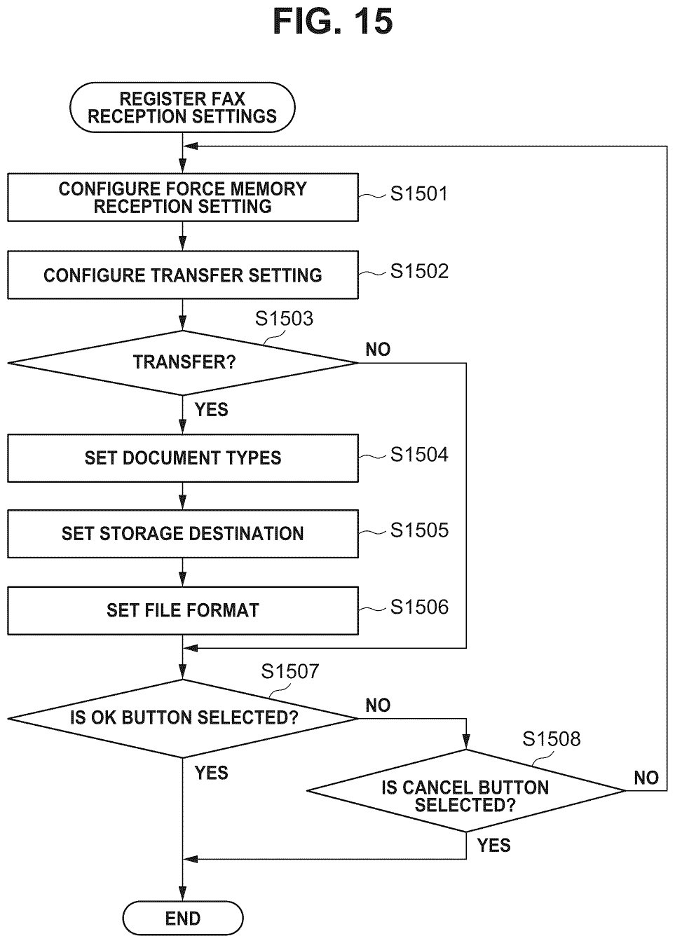

FIG. 15 is a flowchart illustrating an example of FAX reception registration processing according to the present exemplary embodiment. FIG. 14 is a diagram illustrating an example of a FAX reception registration screen according to the present exemplary embodiment.

The FAX reception registration processing is started by the user selecting a FAX reception registration button from a setting menu displayed on the display unit 225 of the image forming apparatus 130. If the FAX reception registration button is selected by the user, the image forming apparatus 130 displays a FAX reception registration screen 1400 on the display unit 225. The selection on the setting menu may be made from the display unit 225 or using a physical button for menu setting. Processing to be performed by the CPU 211 of the image forming apparatus 130 will now be described.

### [Step S1501: Setting Forced Memory Reception]

In step S1501, the CPU 211 accepts the setting of forced memory reception by the user. An input field 1401 of the FAX reception registration screen 1400 is an object for setting whether to force memory reception for FAX reception. If the input field 1401 is set to “yes”, the CPU 211 stores image data received by FAX into the storage 214 of the image forming apparatus 130 and does not print the image data at the same time as the reception. If the input field 1401 is set to “no”, the CPU 211 prints the image data received by FAX simultaneously with the reception. Once the setting of the forced memory reception is completed, the processing proceeds to step S1502.

If the input field 601 of the FAX transmission button registration screen 600 is selected, the CPU 211 displays a not-illustrated software keyboard, and the user can input a desired button name using the software keyboard.

### [Step S1502: Configuring Transfer Setting]

In step S1502, the CPU 211 accepts the user's setting as to whether to transfer the image data that has been received by the image forming apparatus 100 via FAX. An input field 1402 of the FAX reception registration screen 1400 is an object for setting whether to transfer the image data received by FAX. If the user sets the input field 1402 to “yes”, the CPU 211 transfers the image data received by FAX to an external apparatus such as a PC. If the user sets the input field 1402 to “no”, the CPU 211 does not transfer the image data received by FAX. Once the transfer setting is completed, the processing proceeds to step S1503.

### [Step S1503: Determining Transfer]

In step S1503, the CPU 211 determines whether the transfer setting is set to “yes”. If the transfer setting is determined to be set to “yes” (YES in step S1503), the processing proceeds to step S1504. If the transfer setting is determined to be set to “no” (NO in step S1503), the processing proceeds to step S1507.

### [Step S1504: Setting Document Types]

In step S1504, the CPU 211 accepts the user's setting of document types to transfer FAX image data received by FAX. An input field 1403 of the FAX reception registration screen 1400 is an object for registering the document types to transfer the FAX image data received by FAX. If the input field 1403 is selected by the user, the CPU 211 displays a not-illustrated software keyboard, and the user can input and register document types using the software keyboard. In the present exemplary embodiment, FIG. 14 illustrates the input field 1403 with four document types registered. The input to the input field 1403 may be implemented by the user selecting preset options of specific document types. The image forming apparatus 130 may be configured so that a setting file where document types are registered may be read from outside. Any number of document types can be set. Once the setting of the document types is completed, the processing proceeds to step S1505.

### [Step S1505: Setting Storage Destination]

In step S1505, the CPU 211 accepts the setting of the storage destination by the user. An input field 1404 of the FAX reception registration screen 1400 is an object for setting the storage destination in transferring the FAX image data received by FAX. If the input field 1404 is selected by the user, the CPU 211 displays a not-illustrated software keyboard, and the user can input the storage destination using the software keyboard. In FIG. 14, “pharmacy system” is displayed as the storage destination. Specifically, the storage destination is specified by inputting the IP address or Universal Resource Locator (URL) of the storage destination into the input field 1404. The user may register the IP address or URL of the storage destination and a character string such as “pharmacy system” in association with each other in advance, and specify the storage destination by selecting or inputting the character string. Once the setting of the storage destination is completed, the processing proceeds to step S1506.

### [Step S1506: Setting File Format]

In step S1506, the CPU 211 accepts the setting of the file format by the user. An input field 1405 of the FAX reception registration screen 1400 is an object for setting the file format to be used in transferring the FAX image data received by FAX. The user can configure the setting by selecting one from preset file format options. Once the setting of the file format is completed, the processing proceeds to step S1507.

### [Step S1507: Determining Selection of OK Button]

In step S1507, the CPU 211 determines whether an OK button 1406 is selected. The OK button 1406 is an object for storing the data that is input at the time of selection as FAX reception settings. If the OK button 1406 is determined to be selected (YES in step S1507), the CPU 211 stores the data that is input at the time of the selection of the OK button 1406 as FAX reception settings, and the processing ends. If the OK button 1406 is determined to not be selected (NO in step S1507), the processing proceeds to step S1508.

### [Step S1508: Determining Selection of Cancel Button]

In step S1508, the CPU 211 determines whether a cancel button 1407 is selected. The cancel button 1407 is an object for discarding the data that is input at the time of selection and closing the FAX reception registration screen 1400. If the cancel button 1407 is determined to be selected (YES in step S1508), the CPU 211 discards the data that is input at the time of the selection of the cancel button 1407 and closes the FAX reception registration screen 1400, and the processing ends. If the cancel button 1407 is determined to not be selected (NO in step S1508), the processing returns to step S1501.

In the processing of steps S1501 to S1506, all the items do not necessarily need to be set. The order is not limited, either. The processing of steps S1501 to S1506 may be implemented by reading a file where the items are registered in advance into the image forming apparatus 130 from outside.

The determinations in steps S1506 and S1507 are not limited to the inputs from the display unit 225, and may be made with inputs from buttons provided on the operation unit 216 as the determination criteria, for example. Alternatively, the processing of steps S1506 and S1507 may be omitted, and the processing may be automatically ended after a lapse of a predetermined time. The FAX reception settings may be registered from a webpage provided by the image forming apparatus 130, for example. The FAX reception settings may be registered by accessing the image forming apparatus 130 using an external apparatus such as a PC.

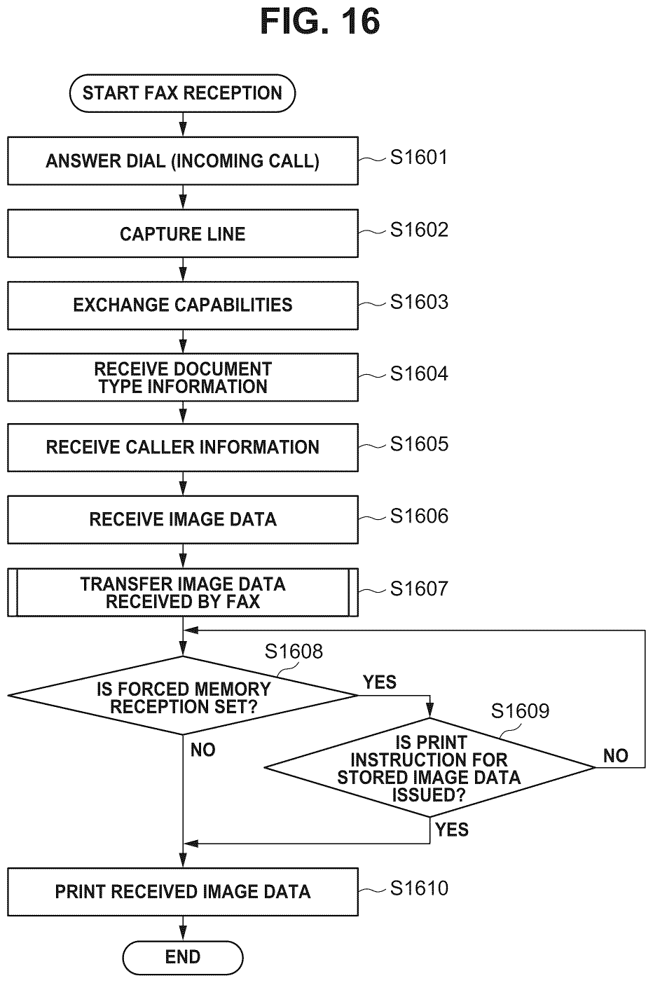

FIG. 16 is a flowchart illustrating an example of FAX reception processing where the image forming apparatus 130 according to the present exemplary embodiment detects FAX transmission from the image forming apparatus 100 and receives the FAX.

### [Step S1601: Answering Dial (Incoming Call)]

In step S1601, the CPU 211 of the image forming apparatus 130 detects the dialing (call origination) by the image forming apparatus 100 in step S912 and starts answering the dial (incoming call). Once the answering to the dial (incoming call) is completed, the processing proceeds to step S1602.

### [Step S1602: Capturing Line]

In step S1602, the CPU 211 of the image forming apparatus 130 captures the line captured by the image forming apparatus 100 in step S911. Once the capturing of the line is completed, the processing proceeds to step S1603.

### [Step S1603: Exchanging Capabilities]

In step S1603, the CPU 211 of the image forming apparatus 130 exchanges capabilities with the image forming apparatus 100 of which the dial is answered in step S1601. In this capability exchange, the CPU 211 and the image forming apparatus 100 exchange information such as the size and type of recording sheets, the modem type, the encoding method, and the recording resolution, whereby transmittable and receivable capability information is mutually exchanged. Once the capability exchange is completed, the processing proceeds to step S1604.

### [Step S1604: Receiving Document Type Information]

In step S1604, the CPU 211 of the image forming apparatus 130 receives the document type information transmitted from the image forming apparatus 100. In the present exemplary embodiment, “prescription” will be described as an example of the document type information. Once the reception of the document type information is completed, the processing proceeds to step S1605.

### [Step S1605: Receiving Caller Information]

In step S1605, the CPU 211 of the image forming apparatus 130 receives the caller information transmitted from the image forming apparatus 100. Once the reception of the caller information is completed, the processing proceeds to step S1606.

### [Step S1606: Receiving Image Data]

In step S1606, the CPU 211 of the image forming apparatus 130 receives the image data transmitted from the image forming apparatus 100 using the line captured in step S1602. Here, the CPU 211 of the image forming apparatus 130 stores the received image data into the storage 214 in the image forming apparatus 130. Once the reception of the image data is completed, the processing proceeds to step S1607.

### [Step S1607: Transferring Image Data Received by FAX]

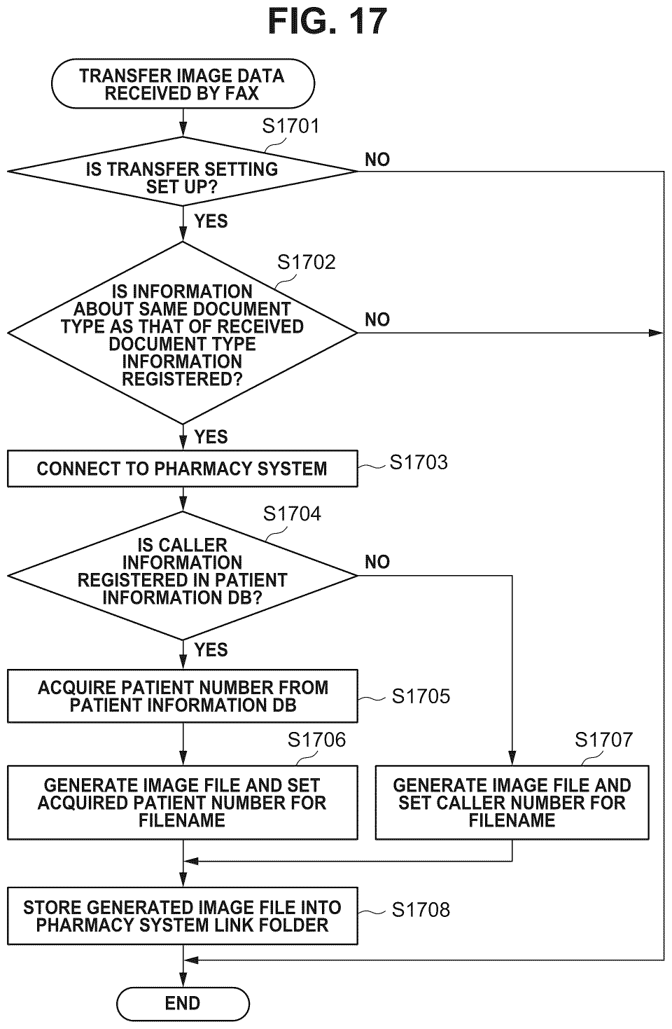

In step S1607, the CPU 211 of the image forming apparatus 130 performs transfer processing (FIG. 17) to be described below on the image data received in step S1606. Once the transfer of the image data received by FAX is completed, the processing proceeds to step S1608.

### [Step S1608: Determining Forced Memory Reception Setting]

In step S1608, the CPU 211 of the image forming apparatus 130 determines whether the forced memory reception is set. If the forced memory reception is determined to be set (YES in step S1608), the processing proceeds to step S1609. If the forced memory reception is determined to not be set (NO in step S1609), the processing proceeds to step S1610.

### [Step S1609: Determining Print Instruction for Image Data]

In step S1609, the CPU 211 of the image forming apparatus 130 determines whether a print instruction for the stored image data is issued. The print instruction for the stored image data can be issued by the user operating the operation unit 216 of the image forming apparatus 130. Alternatively, the print instruction for the stored image data may be issued from an external apparatus such as a PC connected to the image forming apparatus 130, for example. The print instruction for the stored image data may be issued at a set time or set time interval, or automatically issued in response to the user's actions such as login and approach. If the print instruction for the stored image data is determined to be issued (YES in step S1609), the processing proceeds to step S1610. If the print instruction for the stored image data is determined to not be issued (NO in step S1609), the processing returns to step S1608. In such a case, the CPU 211 of the image forming apparatus 130 does not proceed with the processing until the setting of the forced memory reception is reset or the print instruction for the stored image data is issued.

### [Step S1610: Printing Received Image Data]

In step S1610, the printing unit 220 prints the image data received by the image forming apparatus 130 from the image forming apparatus 100 via FAX in step S1606 on a sheet. Once the printing is completed, the CPU 211 of the image forming apparatus 130 deletes the image data stored in step S1606.

FIG. 17 is a flowchart illustrating an example of the processing for transferring the image data received by FAX according to the present exemplary embodiment. Processing to be performed by the CPU 211 of the image forming apparatus 130 will now be described.

### [Step S1701: Determining Transfer Setting]

In step S1701, the CPU 211 determines whether the transfer setting (step S1502) is set up in the FAX reception registration processing (FIG. 15). If the transfer setting is determined to be set up (YES in step S1701), the processing proceeds to step S1702. If the transfer setting is determined to not be set up (NO in step S1701), the processing ends without performing transfer processing.

### [Step S1702: Determining Document Type]

In step S1702, the CPU 211 compares the document type corresponding to the document type information received in step S1604 with the document types to transfer FAX image data, set in step S1504. If information about the same document type as that of the document type information received in step S1604 is determined to be registered in the reception settings (YES in step S1702), the processing proceeds to step S1703. If the information about the same document type is determined to not be registered (NO in step S1702), the processing ends without performing transfer processing.

### [Step S1703: Connecting to Pharmacy System]

In step S1703, the CPU 211 connects to the pharmacy system 140. Once the connection to the pharmacy system 140 is completed, the processing proceeds to step S1704.

### [Step S1704: Determining Registration of Caller Information]

In step S1704, the CPU 211 transmits the caller information, such as the caller number or name, to the pharmacy system 140. The pharmacy system 140 determines whether the transmitted caller information is registered in the patient information DB 1200. If the pharmacy system 140 determines that the received caller number or name is registered in the patient information DB 1200 (YES in step S1704), the processing proceeds to step S1705. If the pharmacy system 140 determines that the received caller number or name is not registered (NO in step S1704), the processing proceeds to step S1707.

[Step S1705: Acquiring Patient Number from DB]

In step S1705, the CPU 211 acquires the patient number of the patient corresponding to the caller information from the patient information DB 1200 of the pharmacy system 140 as identification information. Once the acquisition of the patient number is completed, the processing proceeds to step S1706.

### [Step S1706: Setting Patient Number for Image File Name]

In step S1706, the CPU 211 generates an image file based on the received image data, and sets the patient number acquired from the pharmacy system 140 for the filename of the generated image file. The filename may include only the patient number, or include, e.g., the document type, date, and/or patient name aside from the patient number. An example of the name including the patient number is “ID_10111111_FAXED PRESCRIPTION_20230707130030.pdf” (1302). Once the generation of the image file and the setting of the patient number for the filename are completed, the processing proceeds to step S1708.

### [Step S1707: Setting Caller Number for Image File Name]

In step S1707, the CPU 211 generates an image file based on the received image data, and sets the received caller number for the filename of the generated image file. The filename may include only the caller number, or include, e.g., the document type, date, and/or patient name aside from the caller number. An example of the name including the caller number is “TEL_0320000002_FAXED PRESCRIPTION_20230707130030.pdf” (1314). Once the generation of the image file and the setting of the caller number for the filename are completed, the processing proceeds to step S1708.

[Step S1708: Storage into Link Folder]

In step S1708, the CPU 211 transfers the image file generated in step S1706 or S1707 to the pharmacy system link folder 1300, whereby the image file is stored. The transfer destination of the image file is not limited to the pharmacy system link folder 1300. The image file can be transferred to and stored in a predetermined location set by the user in step S1515.

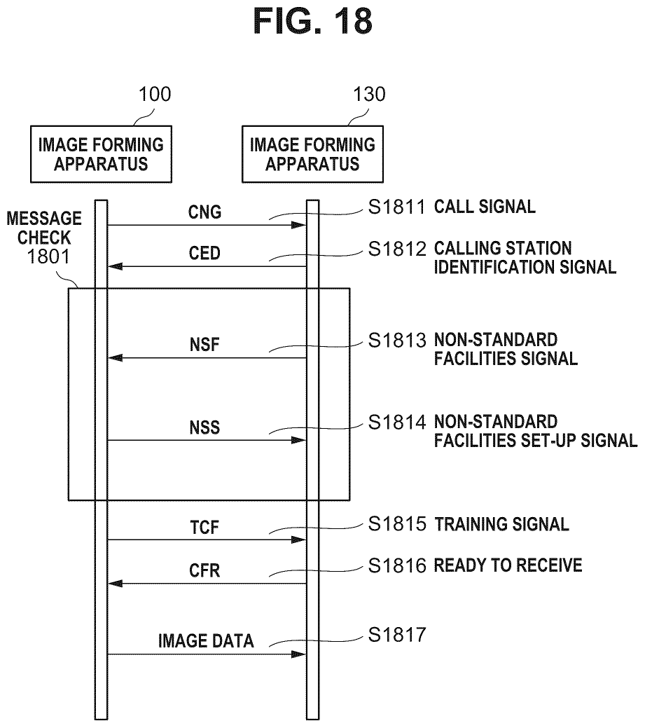

FIG. 18 is a sequence diagram illustrating an example of a signal response sequence during FAX transmission and reception between the image forming apparatuses 100 and 130 according to the present exemplary embodiment. FIG. 18 illustrates signals exchanged between the transmitting and receiving image forming apparatuses 100 and 130 in the FAX transmission processing of FIG. 9 and the FAX reception processing of FIG. 16.

In the present exemplary embodiment, signals other than control signals, such as signals containing the caller information like the patient name and contact number and signals containing the document type information, are transmitted during capability response.

[Step S1811: Call Signal from Transmission Source]

In step S1811, the CPU 211 of the image forming apparatus 100 transmits a call signal to the image forming apparatus 130. The CPU 211 of the image forming apparatus 130 responds to the call signal from the image forming apparatus 100. Once the transmission of the call signal is completed, the sequence proceeds to step S1812.

### [Step S1812: Calling Station Identification Signal]

In step S1812, the CPU 211 of the image forming apparatus 130 transmits a calling station identification signal to the image forming apparatus 100 and thereby notifies of a receivable state. Once the transmission of the calling station identification signal is completed, the sequence proceeds to step S1813.

### [Step S1813: Non-Standard Facilities (NSF) Signal]

In step S1813, the CPU 211 of the image forming apparatus 130 transmits an NSF signal to the image forming apparatus 100, and notifies of receivable settings and capabilities. Once the transmission of the NSF signal is completed, the sequence proceeds to step S1814.

### [Step S1814: Non-Standard Facilities Set-Up (NSS) Signal]

In step S1814, the CPU 211 of the image forming apparatus 100 transmits an NSS signal to the image forming apparatus 130 based on the NSF signal received in step S1813. When transmitting the NSS signal, the image forming apparatus 100 transmits transmission settings of the image data to be transmitted and capabilities. In transmitting signals other than control signals, like signals containing the caller information such as the patient name and contact number and signals containing the document type information, the signals are attached to and transmitted with the NSS signal. Once the transmission of the NSS signal is completed, the sequence proceeds to step S1815.

### [Step S1815: Training Signal]

In step S1815, the CPU 211 of the image forming apparatus 100 transmits a training signal to the image forming apparatus 130 to adjust the receiving conditions of the modem 222 of the image forming apparatus 130. Once the transmission of the training signal is completed, the sequence proceeds to step S1816.

### [Step S1816: Ready to Receive]

In step S1816, the CPU 211 of the image forming apparatus 130 notifies the image forming apparatus 100 that its modem 222 is in a ready-to-receive state. Once the notification of the ready-to-receive state is completed, the sequence proceeds to step S1817.

### [Step S1817: Transmitting Image Data]

In step S1817, the CPU 211 of the image forming apparatus 100 transmits image data to the image forming apparatus 130.

In the present exemplary embodiment, the image data is described to be transmitted by FAX. However, the image data may be transmitted with the image forming apparatuses 100 and 130 connected via the Internet. Examples of the method for transmitting image data via the Internet may include using email, file sharing software, or chat-capable communication software. In the case of email, various types of data including the transmission source information and the image data are transmitted and received using communication standards such as Server Message Block (SMB) and the Simple Mail Transfer Protocol (SMTP). In such a case, not only image files with the extensions tif and jpg, but various files such as text files with the extension txt, compressed files with the extension zip, and application files with the extensions pdf, doc, xls, and ppt can also be transmitted and received.

The patient information is not limited to what is described in the present exemplary embodiment, and refers to any type of attribute information such as gender, age, address, and blood type.

The users described in the present exemplary embodiment are not limited to humans. Other examples may include robots or similar devices that can perform operations equivalent to those of humans, and other information processing apparatuses, such as a PC, that issue input instructions to the information processing apparatuses that are the image forming apparatuses 100 and 130 described in the present exemplary embodiment.

The keyboards for making inputs to the image forming apparatuses 100 and 130 may be displayed on the display units 225 of the operation units 216 of the image forming apparatuses 100 and 130, or provided as physical buttons on the operation units 216. The image forming apparatuses 100 and 130 may be equipped with a microphone, and acquire information from the user through voice input aside from the keyboard input.

The image forming apparatuses 100 and 130 may be equipped with a sensor and configured to recognize gestures, such as the user's hand signs, and start predetermined processing.

If transmission source information such as a FAX number is set as the filename of received image data as discussed in Japanese Patent Application Laid-Open No. 2018-18417, the filename is different from the identification information. In such a case, the recipient consults a database where FAX numbers and identification information are associated, based on the FAX number or other transmission source information set as the filename. The recipient then identifies the individual corresponding to the identification information, and associates the received image data with the individual's identification information. This involves considerable effort.

According to the present exemplary embodiment, a patient registered in the hospital's electronic medical record system 110 or pharmacy system 140 can be identified based on the caller's patient information received by the image forming apparatus 130 via FAX.

Specifically, the image forming apparatus 130 acquires the patient information registered in the system, sets the acquired patient information for the filename of the generated image file, and transmits the image file to the file storage 141. This can facilitate the association of the received image data with the individual.

According to an exemplary embodiment of the present disclosure, received image data can be easily associated with an individual.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-192965, filed Nov. 13, 2023, which is hereby incorporated by reference herein in its entirety.

What is claimed is:

1. An information processing apparatus comprising:
a reception unit configured to receive image data and transmission source information about the image data from an external apparatus;
a generation unit configured to generate a file from the received image data; and
a setting unit configured to acquire identification information corresponding to the received transmission source information from a database, and set a name including the identification information for the generated file.

2. The information processing apparatus according to claim 1, wherein the setting unit is configured to, in a case where the received transmission source information is registered in the database, set the name including the identification information corresponding to the transmission source information for the generated file, and in a case where the received transmission source information is not registered in the database, set a name including the received transmission source information for the generated file.

3. The information processing apparatus according to claim 2, wherein the information processing apparatus is configured to transmit the file to a storage location based on the name of the file set by the setting unit.

4. The information processing apparatus according to claim 3, wherein the information processing apparatus is configured to, in a case where the name of the file set by the setting unit includes the identification information, transmit the file to a storage location named after the identification information.

5. The information processing apparatus according to claim 3, wherein the information processing apparatus is configured to instruct a storage medium to generate the storage location of the file based on the name of the file set by the setting unit.

6. The information processing apparatus according to claim 1, wherein the information processing apparatus is configured to transmit the file to a storage location based on the name of the file set by the setting unit.

7. The information processing apparatus according to claim 6, wherein the information processing apparatus is configured to, in a case where the name of the file set by the setting unit includes the identification information, transmit the file to a storage location named after the identification information.

8. The information processing apparatus according to claim 6, wherein the information processing apparatus is configured to instruct a storage medium to generate the storage location of the file based on the name of the file set by the setting unit.

9. The information processing apparatus according to claim 1, the transmission source information is a sender name.

10. The information processing apparatus according to claim 1, wherein the transmission source information is a transmission source number.

11. The information processing apparatus according to claim 1, wherein the reception unit is configured to receive the image data and the transmission source information about the image data by facsimile (FAX).

12. The information processing apparatus according to claim 1, wherein the reception unit is configured to receive the image data and the transmission source information about the image data by email.

13. The information processing apparatus according to claim 1, wherein the reception unit is configured to receive the transmission source information about the image data using a non-standard facilities set-up (NSS) signal.

14. The information processing apparatus according to claim 1, wherein the setting unit is configured to acquire the identification information corresponding to the received transmission source information from the database, the database being located outside the information processing apparatus.

15. The information processing apparatus according to claim 1, further comprising a printing unit configured to print an image based on the image data on a sheet.

16. An information processing method comprising:
receiving image data and transmission source information about the image data from an external apparatus;
generating a file from the received image data; and
acquiring identification information corresponding to the received transmission source information from a database, and setting a name including the identification information for the generated file.

17. A non-transitory computer-readable storage medium for storing a program causing an information processing apparatus to perform an information processing method, the information processing method comprising:
receiving image data and transmission source information about the image data from an external apparatus;
generating a file from the received image data; and
acquiring identification information corresponding to the received transmission source information from a database, and setting a name including the identification information for the generated file.
